(19) United States
(12) Patent Application Publication
(10) Pub. No.: US 2026/0264529 A1
(43) Pub. Date: Sep. 10, 2026

(54) DRIVING FORCE CONTROL APPARATUS FOR ELECTRIC VEHICLE

(71) Applicant: TOYOTA JIDOSHA KABUSHIKI KAISHA, Toyota-shi (JP)

(72) Inventor: Kazuya OKUMURA, Mishima-shi (JP)

(73) Assignee: TOYOTA JIDOSHA KABUSHIKI KAISHA, Toyota-shi (JP)

(21) Appl. No.: 19/435,451

(22) Filed: Dec. 29, 2025

(30) Foreign Application Priority Data
Mar. 6, 2025 (JP) 2025-035376

(51) Int. Cl. B60L 7/16

(52) U.S. Cl. CPC B60L 7/16; B60L 2210/40

(57) ABSTRACT

A driving force control apparatus for an electric vehicle includes an anti-lock brake system (ABS). The apparatus includes a controller configured to: set a target speed as a target value of a rotational speed of a motor during operation of the ABS, and control regenerative torque so that the rotational speed of the motor approaches the target speed; and extract a predetermined vibration component occurring in the rotational speed of the motor during operation of the ABS, and control the regenerative torque to cancel the predetermined vibration component, wherein the controller is configured to, during operation of the ABS and in response to the regenerative torque being equal to or less than a torque threshold value, prioritize controlling the regenerative torque to cancel the predetermined vibration component over controlling the regenerative torque to make the rotational speed of the motor approach the target speed.

### CROSS REFERENCE TO THE RELATED APPLICATION

This application claims the benefit of Japanese Patent Application No. 2025-035376, filed on Mar. 6, 2025, which is hereby incorporated by reference herein in its entirety.

### BACKGROUND

### Technical Field

This disclosure relates to the drive force control device of an electric vehicle.

### Description of the Related Art

In electric vehicles, vibration control to suppress vibration and slip control to suppress drive wheel slip when the slip rate of the drive wheel exceeds a pre-set threshold, and vibration control is stopped when the drive wheel is determined to be not gripping the road surface, and vibration control is performed when the drive wheel is determined to be gripping the road surface (e.g., See Patent Document 1).

### Citation List

### Patent Literature

Patent Literature 1:Japanese Patent No. 2024-113287

### SUMMARY

The purpose of this disclosure is to suppress the decrease in the accuracy of ABS control due to drive system vibration.

One aspect of the present disclosure is directed to a driving force control apparatus for an electric vehicle including an anti-lock braking system (ABS), the driving force control apparatus for the electric vehicle including:

a controller configured to:

set a target speed as a target value of a rotational speed of a motor during operation of the ABS, and control regenerative torque so that the rotational speed of the motor approaches the target speed; and

extract a predetermined vibration component occurring in the rotational speed of the motor during operation of the ABS, and control the regenerative torque to cancel the predetermined vibration component,

wherein the controller is configured to, during operation of the ABS and in response to the regenerative torque being equal to or less than a torque threshold value, prioritize controlling the regenerative torque to cancel the predetermined vibration component over controlling the regenerative torque to make the rotational speed of the motor approach the target speed.

According to this disclosure, the accuracy of ABS control can be suppressed due to vibration in the drive system.

### BRIEF DESCRIPTION OF THE DRAWINGS

FIG. 1 is a top view showing a schematic view of the vehicle pertaining to the embodiment.

FIG. 2 shows the time chart showing the changes in speed, slip control torque, motor speed vibration component, vibration suppression torque, and output torque during ABS control, in order from top to bottom.

FIG. 3 shows the flowchart showing the control flow in the ECU pertaining to the first embodiment.

FIG. 4 shows the time chart showing the changes in speed, slip control torque, motor speed vibration component, vibration suppression torque, and output torque during ABS control, in order from top to bottom.

FIG. 5 is a flowchart showing the control flow in the ECU pertaining to the second embodiment.

### DESCRIPTION OF THE EMBODIMENTS

It is known that during ABS control, the motor speed is controlled to be close to a target speed by regenerative torque control. This regenerative torque control greatly reduces the braking force when the wheels slip significantly. However, if the regenerative torque is less than 0, the driving force is applied to the wheels, which accelerates the vehicle. In this way, in order to suppress the acceleration of the vehicle during braking, the lower limit of torque is set for the regenerative torque. However, if the regenerative torque drops to the lower limit of torque, the vibration generated by the drive system cannot be suppressed, and the deterioration of controllability due to the vibration of the wheel speed may reduce the sense of deceleration and the sense of stability of the vehicle. In other words, there is a risk that the accuracy of ABS control will be reduced.

Therefore, a driving force control apparatus for an electric vehicle, which is one of the aspects of this disclosure, is a driving force control apparatus for an electric vehicle includes an anti-lock braking system (ABS), the driving force control apparatus for the electric vehicle includes a controller configured to: set a target speed as a target value of a rotational speed of a motor during operation of the ABS, and control regenerative torque so that the rotational speed of the motor approaches the target speed; and extract a predetermined vibration component occurring in the rotational speed of the motor during operation of the ABS, and control the regenerative torque to cancel the predetermined vibration component. The ABS is a system that suppresses wheel slip, at least by operating the hydraulic brake device. The target speed is the rotational speed of the motor that can suppress slip. The controller can control the regenerative torque so that the rotation speed of the motor is close to the target speed, so that slip can be suppressed. In addition, the predetermined vibration component is the component of vibration generated in the drive system such as wheels and motors. To offset this vibration, the controller can suppress the vibration of the drive system by controlling the regenerative torque, thereby improving the accuracy of ABS control. In addition, since the rotation speed of the motor also includes the predetermined vibration components mentioned above, the predetermined vibration components can also be suppressed by controlling the regenerative torque so that the rotational speed of the motor is close to the target speed.

Here, if the rotation speed of the motor is too low relative to the target speed, when the controller controls the regenerative torque so that the rotation speed of the motor is close to the target speed when the ABS is operated, the regenerative torque may be too low and the torque may be generated in the direction of accelerating the electric vehicle. Therefore, a torque threshold is set for the regenerative torque. However, when the regenerative torque is controlled so that the motor's rotational speed is close to the target speed, if the regenerative torque is below the torque threshold, the regenerative torque will be fixed at the torque threshold, making it difficult to suppress the predetermined vibration components.

Therefore, the controller is configured to, during operation of the ABS and in response to the regenerative torque being equal to or less than a torque threshold value, prioritize controlling the regenerative torque to cancel the predetermined vibration component over controlling the regenerative torque to make the rotational speed of the motor approach the target speed. In this way, it is possible to control the regenerative torque so that it offsets the predetermined vibration component without being fixed at the torque threshold. This can suppress the deterioration of the accuracy of ABS control due to a given vibration component.

The following is a detailed illustration of the form for implementing this disclosure, with reference to the drawings. However, the dimensions, materials, shapes, relative arrangements, etc. of the components described in this embodiment are not intended to limit the scope of this disclosure to them alone, unless otherwise stated.

### First Embodiment

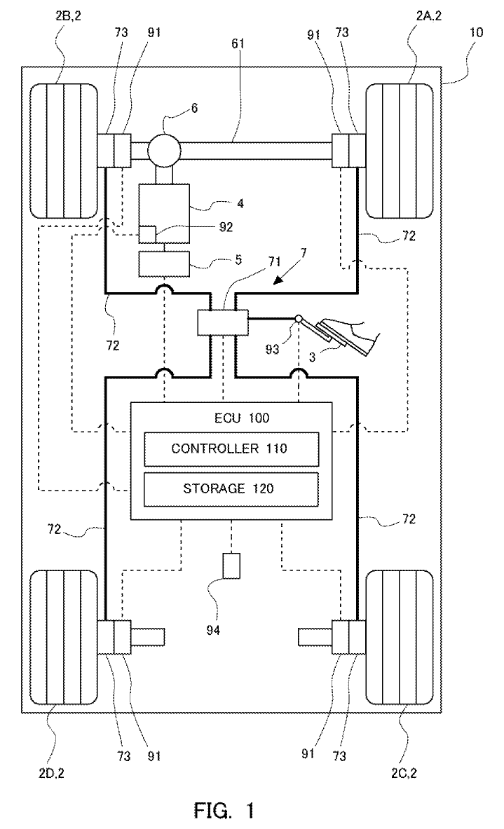

FIG. 1 is a top view showing a schematic view of a vehicle 10 pertaining to this embodiment. The vehicle 10 is equipped with a right front wheel 2A, a left front wheel 2B, a right rear wheel 2C, a left rear wheel 2D, a brake pedal 3, a motor 4, an inverter 5, a differential gear 6, a hydraulic brake device 7, and an ECU 100. In addition, if the right front wheel 2A, the left front wheel 2B, the right rear wheel 2C, and the left rear wheel 2D are not distinguished, it is called a wheel 2. The vehicle 10 is an electric vehicle (BEV: Battery Electric Vehicle) that activates the motor 4 and the wheel 2 by supplying battery power to the motor 4 through the inverter 5. The motor 4 drives the right front wheel 2A and the left front wheel 2B through the differential gear 6 and an axle 61. This causes the vehicle 10 to run.

The brake pedal 3 is connected to the hydraulic brake device 7. The hydraulic brake device 7, has an ABS actuator 71, a brake line 72, and a brake 73. When the user of the vehicle 10 depresses the brake pedal 3, the hydraulic pressure according to an amount of depression is applied to the brake 73 arranged on the wheel 2 through the ABS actuator 71 and each brake line 72. Then, in response to this hydraulics, the brake pads of the brake 73 are pushed out. In addition, this brake pad pinches the disc that is fixed to the wheel 2. As a result, in the wheel 2, friction is generated between the brake pads and the disc, and braking force is generated on the wheel 2. Thus, the hydraulic brake device 7 mechanically brakes the wheel 2.

In addition, the vehicle 10 can perform regenerative braking by the motor 4. In the vehicle 10, when regenerative braking is applied, the motor 4 generates torque in the opposite direction to when driving. This causes the wheel 2 to brake. In this case, the motor 4 uses the torque to act as a generator to supply power to the battery.

The vehicle 10 is further equipped with a wheel rotation speed sensor 91 that detects the rotation speed of the wheel 2 and a motor rotation speed sensor 92 that detects the rotation speed of the motor 4. The detection values by the wheel rotation speed sensor 91 and the motor rotation speed sensor 92 are transmitted to the ECU 100. The wheel rotation speed sensor 91 is provided on each wheel 2, and the rotation speed of each wheel 2 is detected respectively.

The ECU 100 is a computer that controls the braking force in both mechanical braking and regenerative braking of the wheel 2. The ECU 100 may be configured by multiple computers. The ECU 100 has a controller 110 and a storage 120. The controller 110 can be realized by a hardware processor, for example, a CPU etc. In addition, the controller 110 may be configured including RAM, ROM, cache memory, etc. The storage 120 is a means of storing information and consists of a storage medium such as RAM or flash memory. The storage 120 stores the program executed by the controller 110 and the data used by the program.

In addition, the ECU 100 is connected to the ECU 100 by a brake sensor 93 that detects the amount of the user pressing the brake pedal 3 and an accelerometer 94 that detects the acceleration of the vehicle 10 through electrical wiring, and the output signals of the brake sensor 93 and the accelerometer 94 are input to the ECU 100.

The ECU 100 is connected to the ABS actuator 71 through electrical wiring, and the controller 110 of the ECU 100 controls the ABS actuator 71. The controller 110 performs ABS control, which is a control for avoiding or suppressing the lock of the wheel 2 when braking the wheel 2. When the controller 110 receives the amount of depression of the brake pedal 3 from the brake sensor 93, it receives the rotation speed of each wheel 2 from the wheel rotation speed sensor 91. Whereby, the controller 110 calculates the slip rate of each wheel 2, and if the calculated slip rate exceeds the threshold, the ABS actuator 71 applies a hydraulic friction force to each brake 73 based on the said slip rate. This avoids or suppresses the locking of each wheel 2. In addition, the controller 110 controls the ABS actuator 71 for the ABS control, which is known to the ABS control.

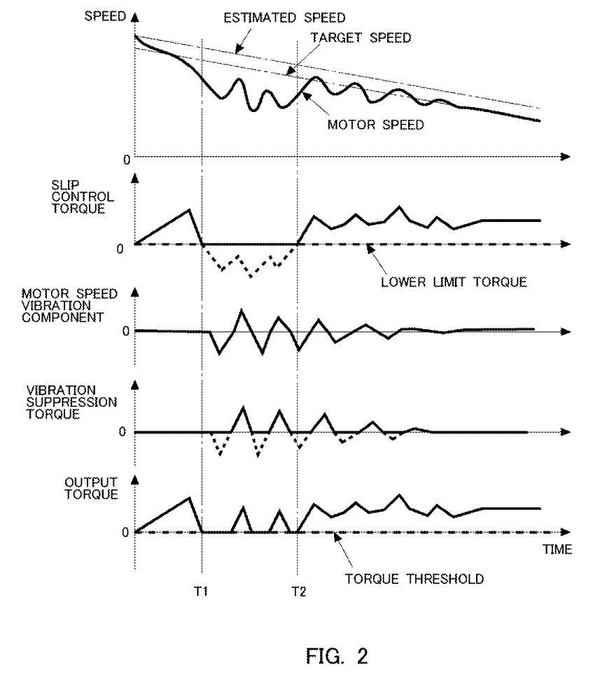

FIG. 2 shows the time chart showing the changes in speed, slip control torque, motor speed vibration component, vibration suppression torque, and output torque during ABS control, in order from top to bottom. The "SPEED" in FIG. 2 is the speed of the vehicle 10 and the speed of the wheel 2 in the contact patch. In FIG. 2, the "ESTIMATED SPEED" is the speed of the vehicle 10 estimated by the controller 110. The estimated speed may be estimated by the controller 110 by calculating the acceleration of vehicle 10 at the time of deceleration from the detection value of the accelerometer 94 and the speed of vehicle 10 before the brake pedal 3 is depressed. Also, the "TARGET SPEED" is, for example, the speed of the wheel 2 on the ground surface, the speed of the wheel 2 with the highest braking force, and the speed to be a target when a slip occurs. "MOTOR SPEED" is the speed of the wheel 2 in the contact patch, which is calculated from the actual rotational speed of the motor 4. In addition, in this embodiment, the speed of the wheel 2 in the contact patch is explained as the speed in FIG. 2 by example, but the rotational speed of the motor 4 can be adopted as the speed instead. In this case, the "ESTIMATED SPEED" in FIG. 2 is the rotational speed of the motor 4 corresponding to the speed of vehicle 10 estimated by the controller 110, the "TARGET SPEED" is the rotational speed of the motor 4 corresponding to the speed of wheel 2 with the highest braking force, and the "MOTOR SPEED" is the rotational speed of the motor 4. Similarly, the speed of rotation of axle 61 can be adopted as the speed in FIG. 2. In other words, a physical quantity that is correlated with the speed of wheel 2 can be adopted.

Here, when the brake pedal 3 is depressed, the estimated speed gradually decreases. And when the wheel 2 slips, the motor speed is lower than the estimated speed. In FIG. 2, the "SLIP CONTROL TORQUE" shows the regenerative torque according to the motor speed, and the regenerative torque according to the speed of the wheel 2 in the contact patch. This slip control torque is also a regenerative torque that suppresses slip. Here, the difference between the target speed and the motor speed is related to the degree of slip. In other words, the greater the difference between the target speed and the motor speed, the greater the amount of slip. When this amount of slip increases, the controller 110 reduces the braking force by reducing the regenerative torque so that the wheel 2 grips the road surface. At this time, the controller 110 sets the slip control torque so that the motor speed approaches the target speed. The controller 110 controls the regenerative torque so that the regenerative torque is not less than the lower limit torque when the regenerative torque is reduced. In FIG. 2, the period from T1 to T2 is the period during which the controller 110 controls the regenerative torque above the lower limit torque. The lower limit torque at this time is, for example, 0. The lower limit of torque is set to 0, for example, so that the vehicle 10 does not accelerate when braking.

In FIG. 2, if the regenerative torque is calculated according to the difference between the estimated speed and the motor speed, the regenerative torque can be negative as shown by the dashed line. Here, when the regenerative torque is negative, torque is generated in the direction of the vehicle 10's acceleration. In this case, there is a risk that the vehicle 10 will accelerate when the wheel 2 grips the road surface even though the user is depressing the brake pedal 3. Therefore, the controller 110 controls the regenerative torque so that the regenerative torque is greater than or equal to the lower limit torque.

In FIG. 2, the "MOTOR SPEED VIBRATION COMPONENT" is the vibration component of the drive system, including the wheel 2, the motor 4, etc., in the motor speed. As shown in the motor speed in FIG. 2, the motor speed changes by repeatedly displacing up and down depending on the vibration component. As a result, the amount of slip fluctuates over a relatively short period of time, so there is a possibility that the controller 110 will not be able to perform appropriate ABS control.

Therefore, the controller 110 receives the detection value of the rotation speed of the motor 4 from the motor rotation speed sensor 92. The controller 110 performs bandpass processing to extract the components of a given frequency band from the detected value of the rotational speed received. Here, the given frequency band is the band that contains the resonant frequency of the drive system. The prescribed frequency band is set according to the size, mass, etc. of the vehicle 10. The predetermined frequency band is pre-remembered in the storage 120 when the vehicle 10 is manufactured.

The controller 110 extracts the components of a predetermined frequency band from the detected value of the rotational speed of motor 4, and then reverses the phase to calculate the regenerative torque ("VIBRATION SUPPRESSION TORQUE" in FIG. 2) according to the vibration component of the motor speed. The vibration suppression torque calculated in this way is the value of the torque required to offset or suppress the vibration component contained in the speed of the target wheel 2. In addition, the vibration suppression torque, like the slip control torque, is set at a lower limit so that it does not become a negative value. Here, in FIG. 2, if the regenerative torque is calculated according to the vibration component, the regenerative torque can be negative as shown by the dashed line. Therefore, if the calculated vibration suppression torque is less than 0, for example, the controller 110 sets the vibration suppression torque to 0.

The "OUTPUT TORQUE" in FIG. 2 is the torque output from the motor 4. Here, since the slip control torque includes the vibration suppression torque, the slip can be suppressed while suppressing the vibration by controlling the motor 4 so that the controller 110 is the slip control torque. However, if the output torque is set to the lower limit torque in the period from T1 to T2, the vibration component cannot be absorbed, and the accuracy of ABS control may be impacted due to the occurrence of vibration.

Therefore, in the present embodiment, when the calculated slip control torque is below the torque threshold, the controller 110 outputs the vibration suppression torque with priority. The torque threshold may be the same value as the lower limit torque (e.g. 0) or the same value as the vibration suppression torque. In the example shown in FIG. 2, the slip control torque is output before T1 in the output torque. In addition, during the period from T1 to T2, vibration suppression torque is output. In addition, after the T2, the slip control torque is output. In addition, in the period before T1 and after T2, the slip control torque also includes the regenerative torque according to the vibration component, so the vibration is suppressed.

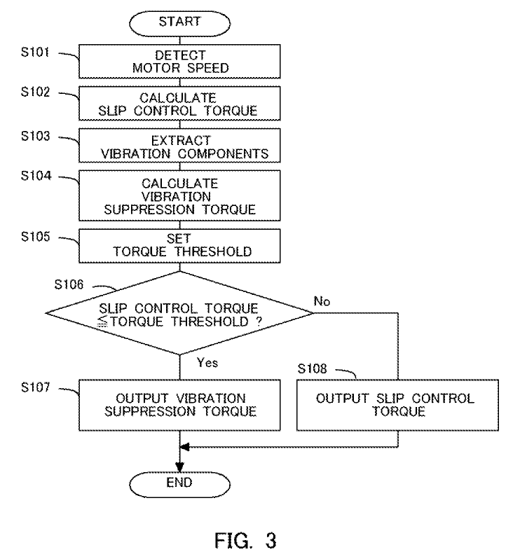

FIG. 3 is a flowchart showing the control flow in the ECU 100 pertaining to the first embodiment. The routine shown in FIG. 3 is repeatedly executed on the ECU 100 at predetermined intervals during ABS control. In step S101, the controller 110 detects the motor speed by the motor rotation speed sensor 92. When the process in step S101 is complete, the process proceeds to step S102.

In step S102, the controller 110 calculates the slip control torque. The controller 110 calculates the slip control torque so that the motor speed approaches the target speed. This formula is remembered in the storage 120. When the process in step S102 is complete, the process proceeds to step S103.

In step S103, the controller 110 extracts the vibration components. The controller 110 extracts the vibration component by performing bandpass processing on the rotational speed of motor 4 detected by the motor rotation speed sensor 92. When the process in step S103 is complete, the process proceeds to step S104.

In step S104, the controller 110 calculates the vibration suppression torque. The controller 110 calculates the vibration suppression torque by reversing the phase of the vibration component extracted in step S103. When the process in step S104 is complete, the process proceeds to step S105.

In step S105, the controller 110 sets the torque threshold. The torque threshold is e.g. 0 or vibration suppression torque. When the process in step S105 is complete, the process proceeds to step S106.

In step S106, the controller 110 determines whether the slip control torque calculated by step S102 is below the torque threshold set in step S105. In step S106, if the controller 110 makes a positive decision, the processing proceeds to step S107, and if it is negative, the processing proceeds to step S108.

In step S107, the controller 110 transmits a command to the inverter 5 so that the vibration suppression torque calculated in step S104 is output from the motor 4. On the other hand, in step S108, the controller 110 transmits a command to the inverter 5 so that the slip control torque calculated in step S102 is output from the motor 4. When the process of step S107 or step S108 is completed, the routine ends.

As explained above, according to the present embodiment, even if the slip control torque becomes 0 during ABS control, the vibration suppression torque is output, so the accuracy of ABS control can be improved.

### Second Embodiment

In the second embodiment, when the amount of slip of wheel 2 is large, the lower limit torque of the slip control torque is expanded to a negative value. Therefore, the controller 110 expands the lower limit torque to a negative value when the motor speed is below the slip threshold.

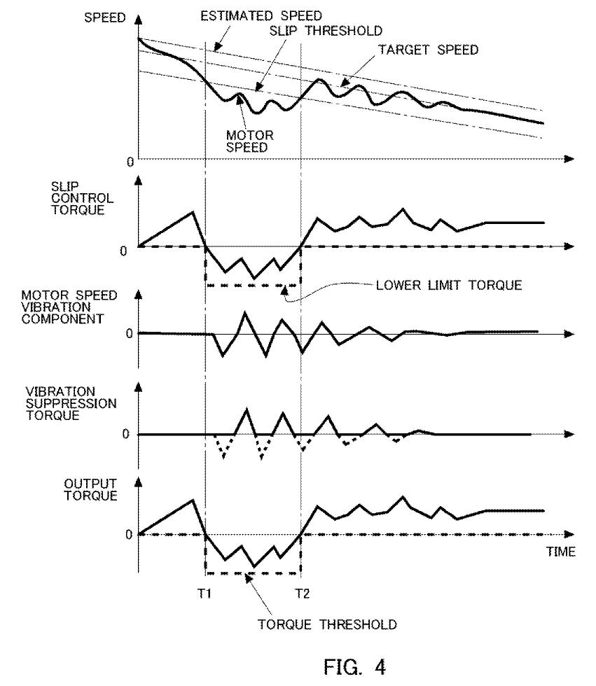

FIG. 4 shows the time chart showing the changes in speed, slip control torque, motor speed vibration component, vibration suppression torque, and output torque during ABS control, in order from top to bottom. The main points that differ from FIG. 2 are explained. In the example shown in FIG. 4, the slip threshold is set at the speed. The slip threshold is the motor speed threshold at which slip is considered to have definitely occurred, even if there are factors such as estimation errors in the estimated speed, because the slip amount of the wheel 2 has become large relative to the estimated speed. Here, it is also possible that there is an error in the estimation of the estimated velocity. For example, it is possible that the detection value of the accelerometer 94 does not accurately represent the deceleration of vehicle 10. In such cases, the estimated velocity includes errors. And if the slip state of the wheel 2 is incorrectly judged by the estimation error, there is a possibility that the vehicle 10 will accelerate due to the regenerative torque, so the lower limit torque in the first embodiment is set to 0, for example. On the other hand, if it is possible to determine with certainty that slippage is occurring, the lower limit torque can be set lower than zero. That is, if a slip is definitely occurring, even if the regenerative torque is set to a negative value, the acceleration of the vehicle 10 can be suppressed and the slip can be quickly resolved.

Therefore, in the second embodiment, the controller 110 sets the slip threshold. The slip threshold is the speed at which the motor speed is thought to not drop to this extent for reasons other than slip. If the motor speed falls below the slip threshold, the controller 110 lowers the lower limit torque. In this way, even if the lower limit torque is set to a negative value, the regenerative torque is used to reduce the amount of slip, so the acceleration of the vehicle 10 is suppressed. In FIG. 4, during the period from T1 to T2, the motor speed is below the slip threshold and the lower limit torque is set to a value lower than 0. Then, the controller 110 also lowers the torque threshold in the output torque by the same reduced amount as the lower limit torque.

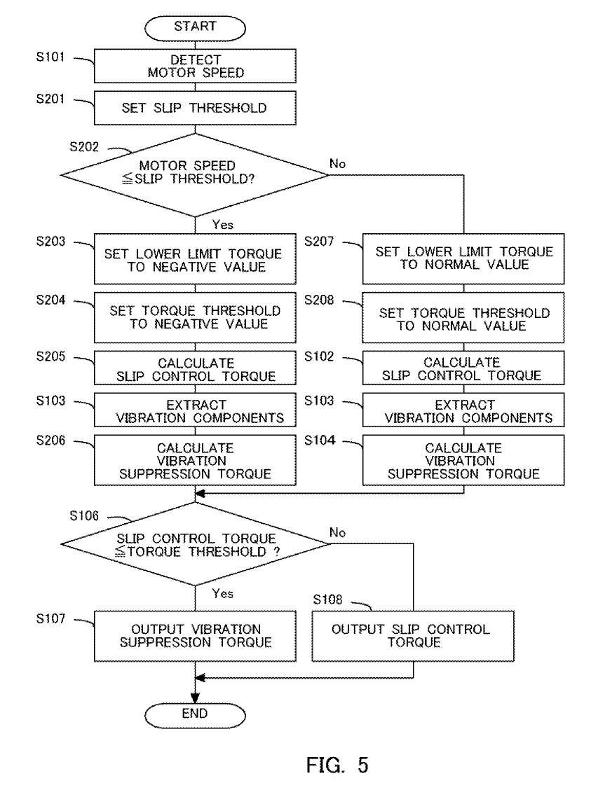

FIG. 5 is a flow chart showing the control flow in the ECU 100 pertaining to the second embodiment. The routine shown in FIG. 5 is repeatedly executed on the ECU 100 at predetermined times during ABS control. In addition, the same code is added to the steps in which the same processing is performed in the routine shown in FIG. 3, and the explanation is omitted.

In the routine shown in FIG. 5, when the process of step S101 is completed, the process proceeds to step S201. In step S201, the controller 110 sets the slip threshold. The slip threshold is a value below the predetermined speed, for example, from the estimated speed. The predetermined speed is the speed at which it can be judged that slip has occurred reliably, even considering the influence of errors. When the process in step S201 is complete, the process proceeds to step S202.

In step S202, the controller 110 determines whether the motor speed is below the slip threshold or not. If the controller 110 makes a positive judgment in step S202, the processing proceeds to step S203, and if it is negative, the processing proceeds to step S207.

In step S203, the controller 110 sets the lower limit torque to a negative value. The lower limit torque at this time is set as a value that reduces the amount of slip. The lower limit torque at this time may be a fixed value or a value according to the motor speed. The logic for calculating the lower limit torque may be memorized in the storage 120. When the process in step S203 is complete, the process proceeds to step S204.

In step S204, the controller 110 sets the torque threshold to a negative value. In this case, the torque threshold may be the same value as the lower limit torque set in step S203, or the same value as the vibration control torque. When the process in step S204 is complete, the process proceeds to step S105.

In step S205, the controller 110 calculates the slip control torque. The controller 110 calculates the slip control torque so that the motor speed approaches the target speed. This formula is remembered in the storage 120. When the slip control torque is less than or equal to the lower limit torque, the controller 110 sets the slip control torque to the lower limit torque. When the process in step S205 is complete, the process proceeds to step S103. In addition, when the process in step S103 is completed, the process proceeds to step S206.

In step S206, the controller 110 calculates the vibration suppression torque. The controller 110 calculates the vibration suppression torque by reversing the phase of the vibration component extracted in step S103. When the slip control torque is less than or equal to the lower limit torque, the controller 110 sets the slip control torque to the lower limit torque. When the process in step S206 is complete, the process proceeds to step S106.

On the other hand, in step S207, the controller 110 sets the lower limit torque to a normal value. The normal value is the value when the motor speed is higher than the slip threshold, and is the same value as the lower limit torque (e.g. 0) set in the first embodiment. When the process in step S207 is complete, the process proceeds to step S208.

In step S208, the controller 110 sets the torque threshold to a normal value. The normal value is the value when the motor speed is higher than the slip threshold and is the same value as the torque threshold set in the first embodiment. When the process in step S208 is complete, the process proceeds to step S102.

As explained above, according to the present embodiment, by setting a slip threshold and expanding the regenerative torque to a negative value, the wheel 2 can be braked more quickly even when the amount of slip is large.

What is claimed is:

1. A driving force control apparatus for an electric vehicle comprising an anti-lock braking system (ABS), the driving force control apparatus for the electric vehicle comprising:
a controller configured to:
set a target speed as a target value of a rotational speed of a motor during operation of the ABS, and control regenerative torque so that the rotational speed of the motor approaches the target speed; and
extract a predetermined vibration component occurring in the rotational speed of the motor during operation of the ABS, and control the regenerative torque to cancel the predetermined vibration component,
wherein the controller is configured to, during operation of the ABS and in response to the regenerative torque being equal to or less than a torque threshold value, prioritize controlling the regenerative torque to cancel the predetermined vibration component over controlling the regenerative torque to make the rotational speed of the motor approach the target speed.

2. The driving force control apparatus for the electric vehicle according to claim 1,
wherein the controller is configured to set the torque threshold value to a negative value when the rotational speed of the motor becomes equal to or less than a slip threshold value during operation of the ABS.

3. The driving force control apparatus for the electric vehicle according to claim 1,
wherein the controller is configured to:
control the regenerative torque so that the rotational speed of the motor approaches the target speed in response to the regenerative torque being greater than the torque threshold value during operation of the ABS; and
control the regenerative torque to cancel the predetermined vibration component in response to the regenerative torque being equal to or less than the torque threshold value during operation of the ABS.
